(19) United States
(12) Patent Application Publication
(10) Pub. No.: US 2026/0094924 A1
(43) Pub. Date: Apr. 2, 2026

(54) BATTERY PACK

(71) Applicant: LG ENERGY SOLUTION, LTD., Seoul (KR)

(72) Inventors: Sang Yoon LEE, Daejeon (KR); Ju Hwan SHIN, Daejeon (KR); Nam Hoon HUR, Daejeon (KR)

(73) Assignee: LG ENERGY SOLUTION, LTD., Seoul (KR)

(21) Appl. No.: 19/110,724

(22) PCT Filed: Dec. 1, 2023
(86) PCT No.: PCT/KR2023/019736

§ 371 Date: Mar. 11, 2025

(30) Foreign Application Priority Data
Dec. 2, 2022 (KR) 10-2022-0167128
Mar. 17, 2023 (KR) 10-2023-0035452
Dec. 1, 2023 (KR) 10-2023-0172135

(51) Int. Cl. H01M 50/291; H01M 10/613; H01M 10/6556; H01M 50/204; H01M 50/242; H01M 50/262

(52) U.S. Cl. CPC H01M 50/291; H01M 10/613; H01M 10/6556; H01M 50/242; H01M 50/262; H01M 50/204

(57) ABSTRACT

A battery pack including a plurality of cell assemblies, and a pack case providing a space in which the cell assemblies are seated, the pack case including: a base plate supporting a lower portion of the cell assemblies; and a separation wall interposed between a pair of neighboring cell assemblies such that each cell assembly is separated, and coupled to the base plate. The separation wall is coupled to the base plate by a coupling member vertically penetrating the bottom of the base plate.

### TECHNICAL FIELD

The present invention relates to a battery pack, wherein a base plate supporting a bottom of a cell assembly and a separation wall interposed between a pair of neighboring cell assemblies are disposed such that the cell assemblies are separated and the separation wall is screwed to the base plate by a coupling member.

This application claims the benefit of priority based on Korean Patent Application No. 10-2022-0167128, filed on Dec. 2, 2022, Korean Patent Application No. 10-2023-0035452, filed on Mar. 17, 2023, and Korean Patent Application No. 10-2023-0172135, filed on Dec. 1, 2023, and the entire contents of the Korean patent application are incorporated herein by reference.

### BACKGROUND ART

The types of secondary batteries include lithium ion batteries, lithium polymer batteries, nickel cadmium batteries, nickel hydrogen batteries, nickel zinc batteries, and the like. The operating voltage of such a unit secondary battery cell, in other words, a unit battery cell, is about 2.5V to 4.2V. Therefore, if a higher output voltage is required, a plurality of battery cells may be connected in series to form a battery pack. Also, depending on the charge and discharge capacity required for the battery pack, a plurality of battery cells may be connected in parallel to form a battery pack. Accordingly, the number of battery cells included in the above battery pack may be varied according to the required output voltage or charge/discharge capacity.

For example, when a plurality of battery cells is connected in series/parallel to form a battery pack, a battery module comprising a plurality of battery cells is first constructed.

FIG. 1 illustrates a pack case 20 included in a conventional battery pack in which cell assemblies 10 are accommodated. The pack case 20 provides a space in which the cell assemblies 10 are each separately accommodated, as shown in FIG. 1. Each cell assembly 10 is supported at a lower portion by a base plate 30 corresponding to the bottom of the pack case 20, supported at a lateral portion by side walls 40 coupled along the rim of the base plate 30, and supported at a lateral portion by a separation wall 50, and can be simultaneously separated.

FIG. 2 illustrates a pack case 20 in which cell assemblies 10 are entirely accommodated, and each cell assembly 10 is separated by a separation wall 50. The pack case 20 may further comprise a main wall 60 across the center as shown in FIG. 2, wherein each cell assembly 10 is seated in a space separated by the main wall 60 and the separation wall 50.

Meanwhile, the separation wall 50 is generally coupled to the base plate 30 by welding.

FIG. 3 schematically illustrates the welding of the separation wall 50 and the base plate 30, wherein the edge portion formed by the coupling of the separation wall 50 and the base plate 30 is welded with a welding torch 70. At this time, a welding bead 80 is generated by the welding, and the welding bead 80 is formed at the edge portion of the separation wall 50 and the base plate 30 as shown in FIG. 3.

However, the welding bead 80 formed by the above welding may hinder the seating of the cell assembly 10.

FIG. 4 is a cross-sectional view of the pack case 20 of FIG. 2, wherein, with reference to FIG. 4, welding beads 80 are formed at both ends of the separation wall 50. The welding beads 80 interfere with the edges of the cell assembly 10 when the cell assembly 10 is seated on the base plate 30; in other words, the cell assembly 10 may not be able to be seated fully on the base plate 30 due to bumping into the welding beads 80 during seated positioning.

Conventional approaches to solving the above contact problems have attempted to expand the internal space of the pack case 20. However, such methods not only increase the weight of the battery pack, but also introduce a new problem in that the cell assembly 10 is not appropriately supported by the separation wall 50.

### DISCLOSURE

### Technical Problem

Therefore, the present invention is directed to solving the above problems, and to provide a battery pack in which the lateral portions of the cell assembly are appropriately supported, and the internal space is efficiently utilized.

Other objects and advantages of the present invention will be understood from the following description, which will become more apparent from the embodiments of the present invention, and it will be easily understood that the objects and advantages of the present invention may be realized by the means and combinations thereof disclosed in the claims of the patent.

### Technical Solution

The present invention provides a battery pack comprising a plurality of cell assemblies; and a pack case having a space in which the plurality of cell assemblies are seated, the pack case including: a base plate configured to support a lower portion of each of the cell assemblies; a separation wall interposed between a pair of neighboring cell assemblies of the plurality of cell assemblies such that each cell assembly of the pair of neighboring cell assemblies is separated; and at least one coupling member vertically penetrating through a bottom of the base plate into the separation wall to couple the separation wall to the base plate.

A bottom of the separation wall may include at least one thread groove, the base plate may include at least one coupling hole through at a location corresponding to the at least one thread groove of the separation wall, and the at least one coupling member may be screwed to the at least one thread groove by penetrating the at least one coupling hole.

The at least one thread groove may include a plurality of thread grooves.

The plurality of thread grooves may be spaced apart at predetermined intervals along a length direction of the separation wall.

The base plate may extend along a length direction of the pack case, and the base plate may include a plurality of cooling passages spaced apart at predetermined intervals therein along a width direction of the pack case.

The at least one coupling member may be inserted between a pair of neighboring cooling passages of the plurality of cooling passages.

A length of the at least one coupling member may be equal to or longer than an intermediate height of the separation wall.

The separation wall may further include: at least one stiffening bar inside the separation wall; and at least one thread groove, and the at least one coupling member may be inserted into the at least one thread groove of the separation wall and may be coupled to the stiffening bar.

The at least one stiffening bar may be a circular column or a polygonal column.

The at least one stiffening bar may include a plurality of stiffening bars, each stiffening bar being spaced apart at predetermined intervals along a height direction of the separation wall.

### Advantageous Effects

According to the present invention, the efficiency of the internal space of the pack case can be improved.

Further, the safety of the battery pack can be improved by stably supporting a lateral portion of a cell assembly including a plurality of cells.

In addition, even if one of the cell assemblies expands due to thermal runaway phenomenon, deformation and explosion of the thermal runaway cell assembly and other cell assemblies in the surroundings can be minimized.

### BRIEF DESCRIPTION OF THE DRAWINGS

FIG. 1 illustrates a pack case included in a conventional battery pack.

FIG. 2 illustrates a conventional pack case accommodating a cell assembly.

FIG. 3 is a schematic drawing of the welding process of a separation wall and a base plate included in a conventional pack case.

FIG. 4 is a cross-sectional view of the pack case of FIG. 2.

FIG. 5 is a plan view of a pack case included in a battery pack according to a first embodiment of the present invention.

FIG. 6 is a bottom view of the pack case of FIG. 5.

FIG. 7 is a bottom perspective view of the pack case of FIG. 5.

FIG. 8 is a cross-sectional view of a portion of a pack case included in in a battery pack according to a first embodiment (before coupling coupling members).

FIG. 9 is a cross-sectional view of a portion of a pack case included in a battery pack according to a first embodiment (after coupling coupling members).

FIG. 10 is a cross-sectional view of a portion of a pack case included in a battery pack according to a second embodiment (before coupling coupling members).

FIG. 11 is a cross-sectional view of a portion of a pack case included in a battery pack according to a second embodiment (after coupling coupling members).

FIG. 12 shows a cross-sectional view of a pack case included in a battery pack according to a third embodiment (before coupling coupling members).

FIG. 13 is a cross-sectional view of a pack case included in a battery pack according to a third embodiment (after coupling coupling members).

FIG. 14 is a perspective view of a stiffening bar inside a separation wall and a coupling member outside the separation wall.

FIG. 15 is a perspective view of a stiffening bar inside the separation wall and a coupling member coupled with the stiffening bar.

FIG. 16 is a schematic drawing of the coupling of the stiffening bar and the coupling member of the separation wall included in the battery pack according to a fourth embodiment of the present invention.

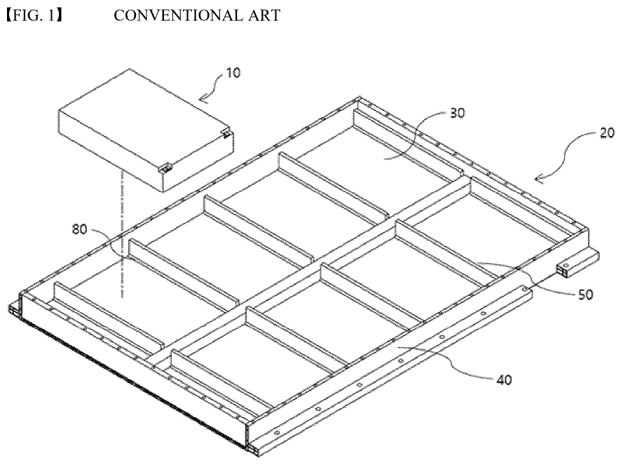

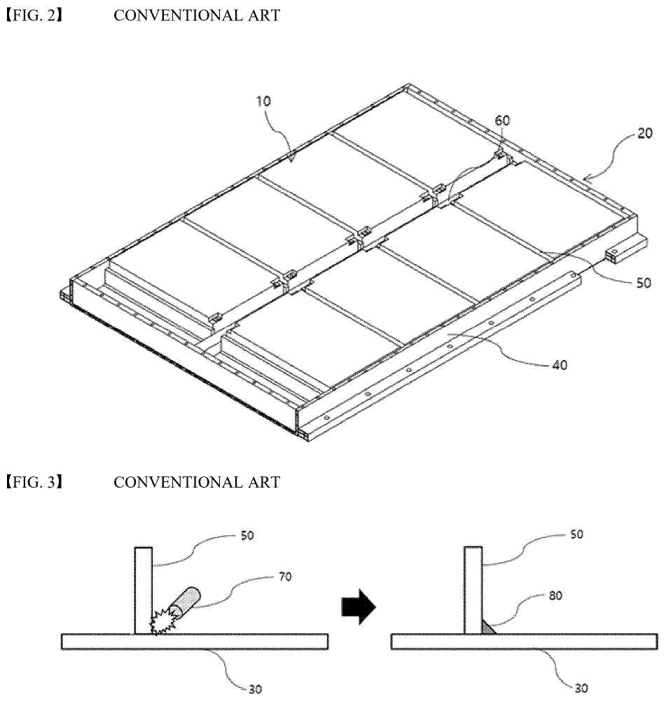

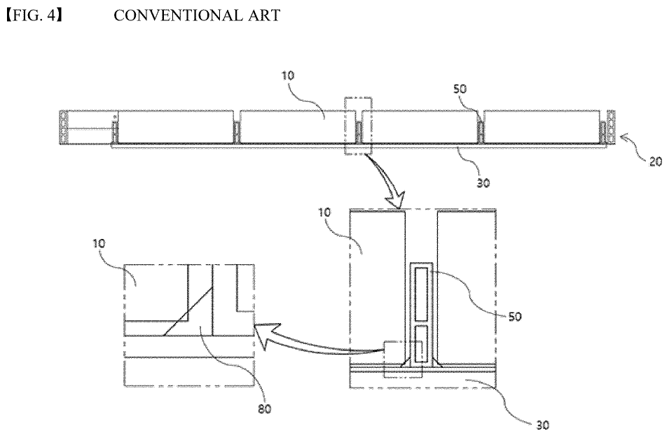

### BEST MODE

The present invention will now be described in detail with reference to the accompanying drawings, which illustrate preferred embodiments of the present invention. It is hereby understood that the terms and words used in this specification and claims are not to be construed in their ordinary or dictionary sense, but are to be interpreted with a meaning and concept consistent with the technical idea of the present invention, based on the principle that the inventor may define the concept of a term as he or she considers appropriate to best describe the invention.

However, it should be understood that the present invention is not limited to the specific embodiments, and includes all modifications, equivalents, or alternatives within the spirit and technical scope of the present invention.

In addition, in describing the present invention, specific descriptions of related disclosed configurations or functions are omitted where it is considered that such detailed description would obscure the subject matter of the present invention.

The present invention is shown in embodiment to more fully explain the present invention to those of ordinary skill in the art, and therefore, the shapes and sizes of the components in the drawings may be exaggerated, omitted, or shown schematically for clarity. Accordingly, the size or proportions of each component are not necessarily indicative of its actual size or proportions.

The present invention relates to a battery pack in which a plurality of cell assemblies are accommodated. More specifically, the battery pack of the present invention is characterized by a base plate supporting the bottom of the cell assemblies and a separation wall interposed between a pair of cell assemblies neighboring to each other such that the cell assemblies are separated, the separation wall is screwed to the base plate by a coupling member.

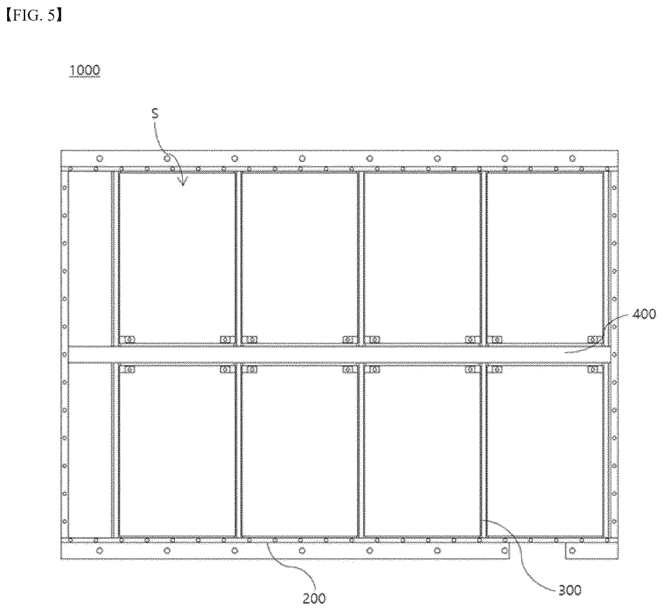

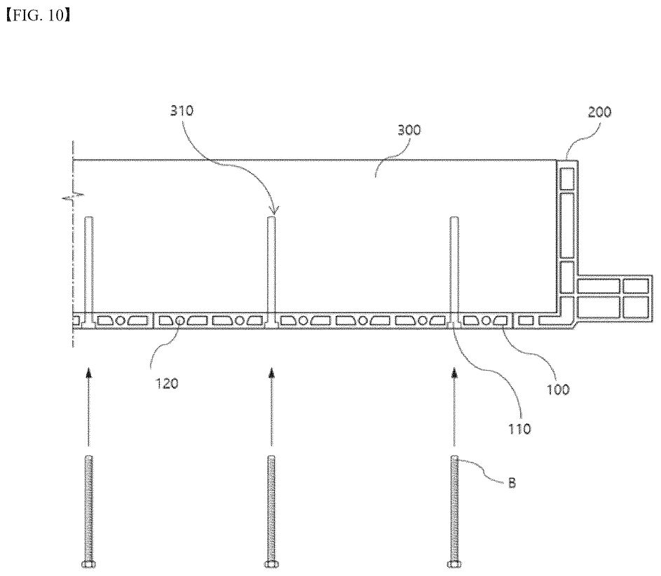

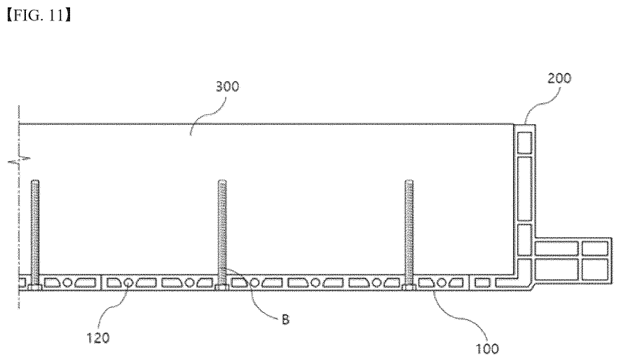

FIGS. 5 to 9 relate to a battery pack according to a first embodiment of the present invention, FIGS. 10 to 11 relate to a battery pack according to a second embodiment of the present invention, FIGS. 12 to 15 relate to a battery pack according to a third embodiment of the present invention, and FIG. 16 relates to a battery pack according to a fourth embodiment of the present invention.

Hereinafter, with reference to the following drawings, a battery pack of the present invention according to each embodiment will be described.

### First Embodiment

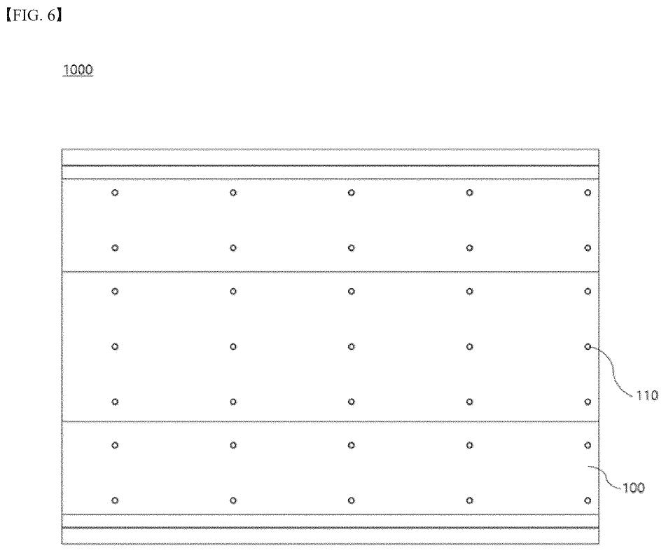

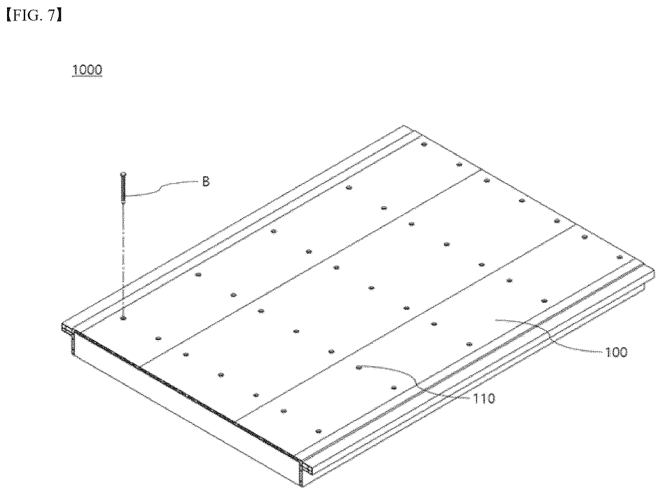

FIG. 5 is a top view of a pack case 1000 included in a battery pack according to a first embodiment of the present invention, FIG. 6 is a bottom view of the pack case 1000 of FIG. 5, and FIG. 7 is a bottom perspective view of the pack case 1000 of FIG. 5.

The battery pack of the present invention is accommodated with a plurality of cell assemblies S.

The cell assembly S comprises a cell block including a plurality of cells.

The cell comprises an electrode assembly with electrodes including negative and positive electrodes and separators stacked alternately, electrode leads electrically connected to the electrodes, and a cell case enclosing and sealing the electrode assembly such that the electrode leads protrude to the outside.

The cell may be divided into cylindrical cells, prismatic cells and pouch-type cells according to the shape of the electrode assembly and the battery case.

In the cylindrical cell, the electrode assembly is rolled in the form of a roll and inserted into a cylindrical battery cell case.

In the he prismatic cell, the electrode assembly may be in the form of a stack in which the electrodes and the separator are alternately stacked, and may be in the form of a stack-folding in which the electrodes and the like are provided on a sheet-shaped separator folded at regular intervals.

In the prismatic cell, the electrode assembly is inserted into a battery cell case in the form of a square box.

In the pouch-type cell, the electrode assembly may be in a stacked form, or may be in a stack-folding form.

In the pouch-type cell, said electrode assembly is inserted within a pouch-type battery cell case.

Thus, the cell assembly may include any one of cylindrical cells, prismatic cells, and pouch-type cells.

The cell assembly S includes a plurality of cells and a busbar frame including a busbar in electrical connection with electrode leads included in each of the cells.

The cell assembly S may further include a module frame surrounding a periphery of the cell block such that each cell is protected from external impact. In this case, the module frame may be provided to support or protect only a portion of the cell block, or may be provided on all exposed portions of the cell block to completely block the cell block from the outside.

The battery pack of the present invention includes a pack case 1000, which is shaped to enclose and support a lateral portion and a lower portion of the cell assemblies S, and in which the cell assemblies S are directly accommodated. It may also include an upper case coupling with the pack case 1000 to cover an upper portion of each cell assembly S. However, the upper portion of the case is less relevant to the features of the present invention and will not be described.

The pack case 1000 serves to provide a space in which the cell assembly S is seated, and to protect the seated cell assembly S from external impacts and the like.

The pack case 1000 basically includes a base plate 100, a side wall 200, and a separation wall 300.

The base plate 100 serves to support a lower portion of the cell assembly S, and a cooling passage 120 for cooling the cell assembly S may be formed therein as needed.

The side walls 200 serve to support, enclose and protect the lateral portions of the cell assemblies S seated on the base plate 100, and are coupled along the rim of the base plate 100 as shown in FIG. 5.

The separation wall 300 is interposed between a pair of neighboring cell assemblies S such that each cell assembly S is separated, and coupled to the base plate 100 as shown in FIG. 5.

The pack case 1000 may further include a main wall 400 extending across the center and coupling to the base plate 100 as shown in FIG. 5.

The main wall 400 serves to separate the cell assemblies S while dividing the internal space of the pack case 1000 into two large compartments.

The main wall 400 may be provided with conductors and busbars or the like therein.

A plurality of cell assemblies S accommodated in the pack case 1000 are seated in respective spaces divided by the separation walls 300 and the main wall 400, as shown in FIG. 5.

The battery pack of the present invention is characterized in that the separation wall 300 configured to divide the space inside the pack case 1000 is screwed to the base plate 100, in other words, the separation wall 300 is coupled to the base plate 100 by a coupling member B which vertically penetrates the bottom of the base plate 100.

The coupling member B may be a bolt or the like capable of being screwed together, but the present invention does not limit the specific kind thereof.

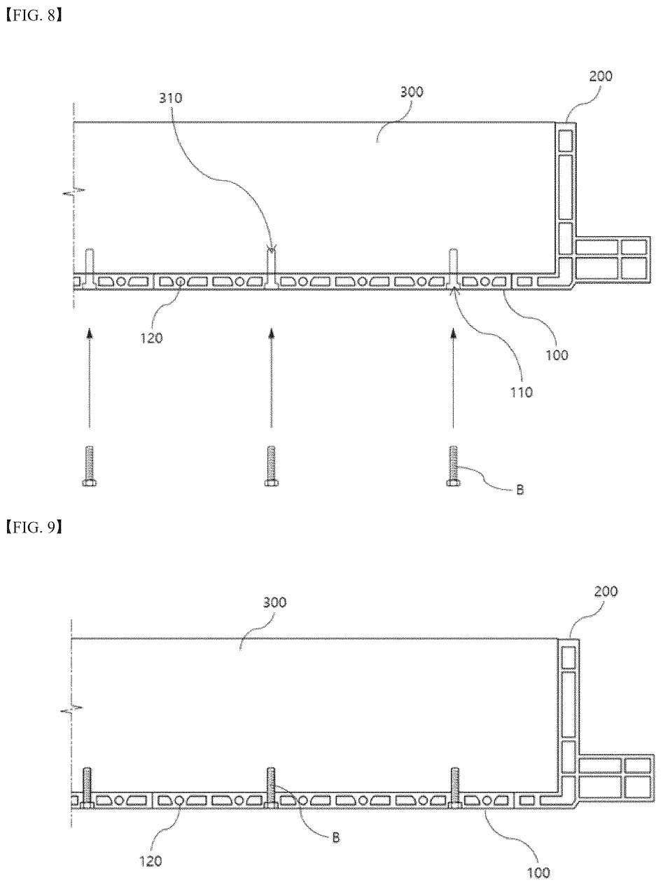

FIGS. 8 and 9 are cross-sectional views of a portion of a pack case 1000 included in a battery pack according to a first embodiment of the present invention. Specifically, FIG. 8 shows the coupling member B before coupling the coupling member B with the separation wall 300, and FIG. 9 shows the coupling member B after coupling the coupling member B with the separation wall 300.

Referring to FIGS. 7 to 9, the separation wall 300 includes a thread groove 310 at its bottom, and the base plate 100 includes a coupling hole 110 formed at a position corresponding to the thread groove 310 of the separation wall 300. In other words, when the separation wall 300 is firstly coupled with the base plate 100, the thread groove 310 of the separation wall 300 and the coupling hole 110 of the base plate 100 are matched.

The coupling member B is screwed to the threaded grooves 310 through the coupling holes 110 to secure the separation wall 300 to the base plate 100.

The separation wall 300 may include a plurality of thread grooves 310, and the base plate 100 includes a plurality of coupling holes 110 corresponding to each of the thread grooves 310.

The plurality of thread grooves 310 may be formed at predetermined intervals spaced apart along the longitudinal direction of the separation wall 300, and the plurality of coupling members B are each in turn coupled along the length direction of the separation wall 300.

When the base plate 100 is provided with cooling passages 120, the cooling passages 120 extend along the length direction of the pack case 1000 and are spaced apart at predetermined intervals along the width direction of the pack case 1000, as shown in FIGS. 8 to 9.

The coupling holes 110 and thread grooves 310 may be positioned and formed to be interposed between the cooling passages 120, and the coupling member B may be inserted between the cooling passages 120 and coupled to the separation wall 300.

### Second Embodiment

The battery pack according to the second embodiment of the present invention is characterized by an elongated length of the coupling member B used to fix the separation wall 300.

FIGS. 10 and 11 show cross-sections of a portion of the pack case 1000 included in the battery pack according to the second embodiment of the present invention. Specifically, FIG. 10 is shown before coupling the coupling member B to the separation wall 300, and FIG. 11 is shown after coupling the coupling member B to the separation wall 300.

The coupling member B is characterized in that the coupling member B has a length of more than the intermediate height of the separation wall 300.

When the long length coupling member B is used, it is inserted equal to or longer tha n the intermediate height of said separation wall 300, thereby improving the mechanical strength of the separation wall 300, in other words, improving the resistance of the separation wall 300 to external forces acting in the horizontal direction due to the coupling member B. For example, if the accommodated cell assembly S has a problem and expands, the separation wall 300 and the coupling members B inserted in the separation wall 300 can fully withstand the expansion force transmitted from the cell assembly S.

### Third Embodiment

The battery pack according to a third embodiment of the present invention is characterized in that it further includes a stiffening bar 320 inside the separation wall 300, and the coupling member B is coupled with the stiffening bar 320 so that the mechanical strength of the separation wall 300 is improved. In other words, the battery pack according to the third embodiment is characterized by the addition of a stiffening bar 320 configuration to the coupling member B of the battery pack according to the second embodiment.

The stiffening bar 320 may be, but is not limited to, steel or the like, and may include any material having high mechanical strength and relatively light weight.

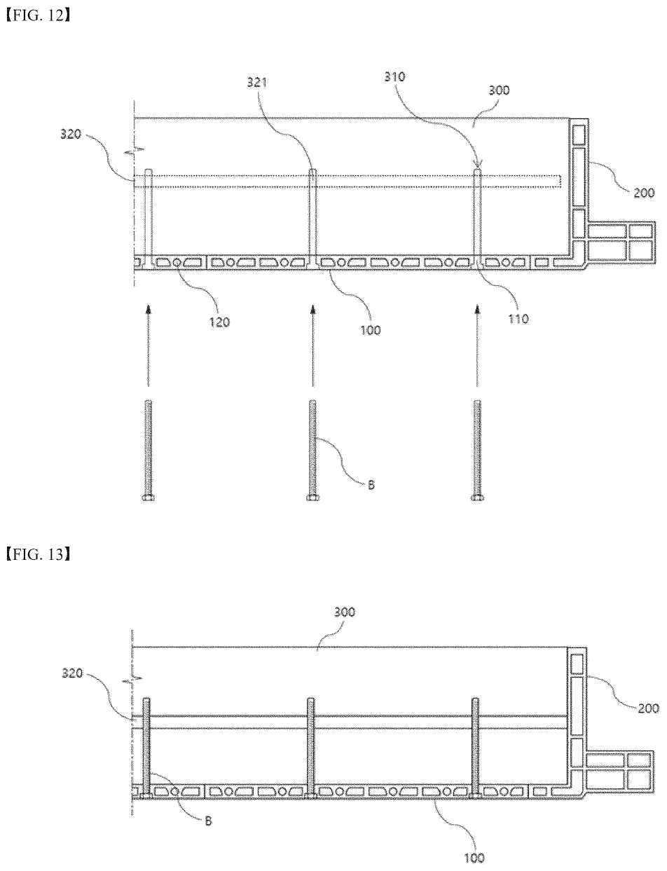

FIGS. 12 and 13 illustrate cross-sectional views of a pack case 1000 included in a battery pack according to a third embodiment. Specifically, FIG. 12 illustrates a stiffening bar 320 inside a separation wall 300 and a coupling member B coupling with the stiffening bar 320, while FIG. 13 illustrates the coupling of the stiffening bar 320 of FIG. 12 with the coupling member B.

The separation wall 300 further includes a stiffening bar 320 on its interior as shown in FIGS. 12 and 13, and the coupling member B is inserted into a thread groove 310 of said separation wall 300 to couple with the stiffening bar 320.

The stiffening bar 320 is provided inside the separation wall 300 and extends along the length direction of the separation wall 300, so that when an external force is applied to either side of the separation wall 300, it can be dispersed through the stiffening bar 320. In addition, the separation wall 300 can more effectively resist an external force acted in a horizontal direction through the coupling member B coupled to the stiffening bar 320.

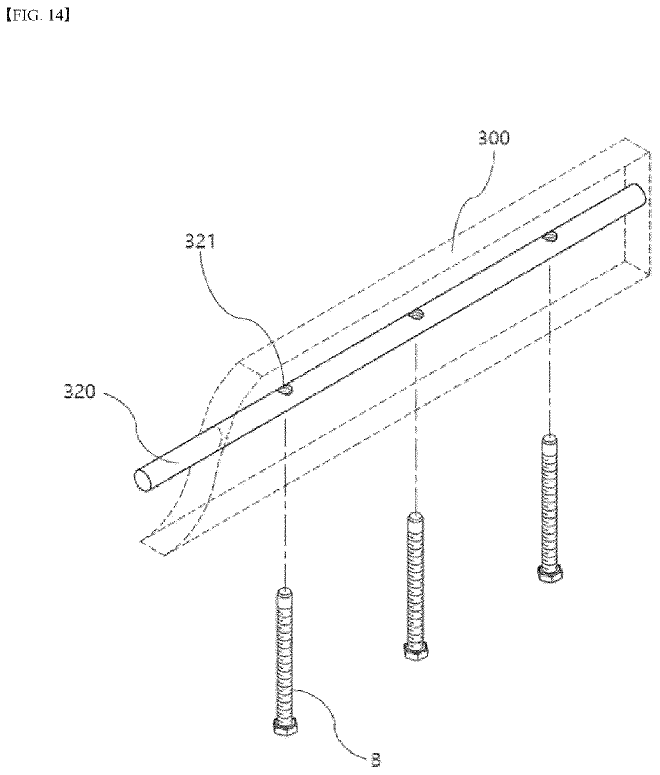

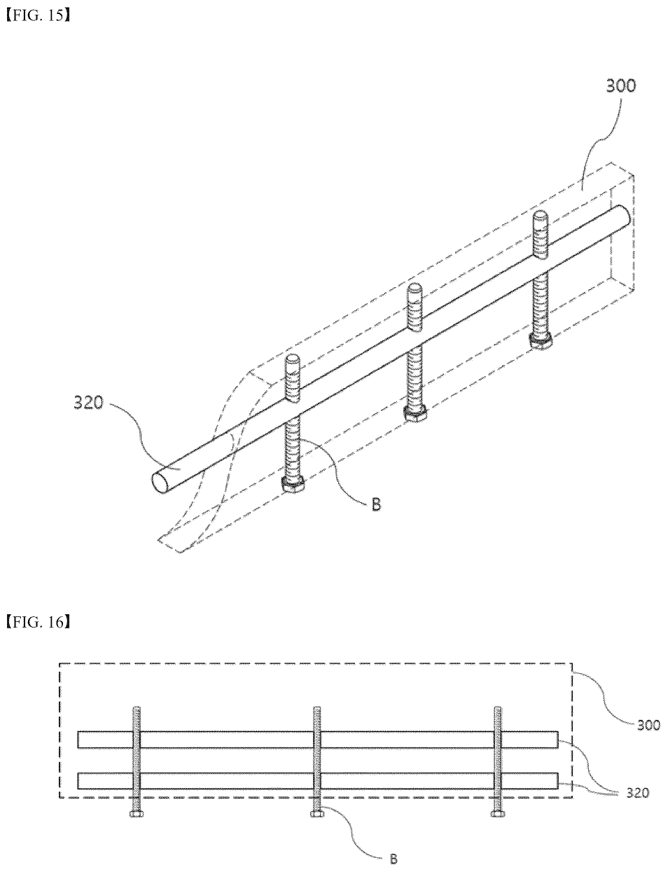

FIG. 14 is a perspective view of a stiffening bar 320 inside the separation wall 300 and a coupling member B outside the separation wall 300, and FIG. 15 is a perspective view of a stiffening bar 320 inside the separation wall 300 and a coupling member B coupled to the stiffening bar 320.

The stiffening bar 320 includes a plurality of stiffening holes 321 formed through positions corresponding to the thread grooves 310. Thus, the coupling member B inserted into the thread groove 310 can be coupled with the stiffening bar 320 while passing through the stiffening holes 321 of said stiffening bar 320.

The stiffening bar 320 may be in the form of a circular column as shown in FIGS. 14 and 15, but is not limited thereto and may also be a polygonal column.

### Fourth Embodiment

The battery pack according to the fourth embodiment of the present invention is characterized in that a plurality of the stiffening bars 320 included in the battery pack of the third embodiment are used.

FIG. 16 is a schematic depiction of the coupling of the stiffening bars 320 and the coupling member B of the separation wall 300 included in the battery pack according to the fourth embodiment of the present invention.

The separation wall 300 includes a plurality of stiffening bars 320 as shown in FIG. 16, each stiffening bar 320 being spaced apart at predetermined intervals along a height direction of the separation wall 300.

In this case, each of the stiffening bars 320 is positioned such that the coupling member B inserted into the separation wall 300 penetrates all of the stiffening bars 320.

As above, the present invention has been described in more detail through the drawings and embodiments. However, since the configuration described in the drawings or embodiments described herein is merely one embodiment of the present invention and do not represent the overall technical spirit of the invention, it should be understood that the invention covers various equivalents, modifications, and substitutions at the time of filing of this application.

### DESCRIPTION OF REFERENCE NUMERALS

10: (conventional art) cell assembly
20: (conventional art) pack case
30: (conventional art) base plate
40: (conventional art) side wall
50: (conventional art) separation wall
60: (conventional art) main wall
70: (conventional art) welding torch
80: (conventional art) welding bead
1000: pack case
100: base plate
110: coupling hole
120: cooling passage
200: side wall
300: separation wall
310: thread groove
320: stiffening bar
321: stiffening hole
400: main wall
S: cell assembly
B: coupling member

1. A battery pack comprising:
a plurality of cell assemblies; and
a pack case having a space in which the plurality of cell assemblies are seated, the pack case including:
a base plate configured to support a lower portion of each of the cell assemblies;
a separation wall interposed between a pair of neighboring cell assemblies of the plurality of cell assemblies such that each cell assembly of the pair of neighboring cell assemblies is separated; and
least one coupling member vertically penetrating through a bottom of the base plate into the separation wall to couple the separation wall to the base plate.

2. The battery pack of claim 1, wherein a bottom of the separation wall includes at least one thread groove,
wherein the base plate includes at least one coupling hole at a location corresponding to the at least one thread groove of the separation wall, and
wherein the at least one coupling member is screwed to the at least one thread groove by penetrating the at least one coupling hole.

3. The battery pack of claim 2, wherein the at least one thread groove includes a plurality of thread grooves.

4. The battery pack of claim 3, wherein the plurality of thread grooves are spaced apart at predetermined intervals along a length direction of the separation wall.

5. The battery pack of claim 1, wherein the base plate extends along a length direction of the pack case, the base plate having a plurality of cooling passages spaced apart at predetermined intervals therein along a width direction of the pack case.

6. The battery pack of claim 5, wherein the at least one coupling member is inserted between a pair of neighboring cooling passages of the plurality of cooling passages.

7. The battery pack of claim 1, wherein a length of the at least one coupling member is equal to or longer than an intermediate height of the separation wall.

8. The battery pack of claim 1, wherein the separation wall further includes:
at least one stiffening bar inside the separation wall; and
at least one thread groove, and
wherein the at least one coupling member is inserted into the at least one thread groove of the separation wall and is coupled to the at least one stiffening bar.

9. The battery pack of claim 8, wherein the at least one stiffening bar is a circular column or a polygonal column.

10. The battery pack of claim 8, wherein the at least one stiffening bar includes a plurality of stiffening bars, each stiffening bar being spaced apart at predetermined intervals along a height direction of the separation wall.
